(19) United States
(12) Patent Application Publication
(10) Pub. No.: US 2006/0152601 A1
(43) Pub. Date: Jul. 13, 2006

(54) Low cost digital camera with one-time programmable memory

(75) Inventor: Kunal R. Parekh, Boise, ID (US)

Correspondence Address: DICKSTEIN SHAPIRO MORIN & OSHINSKY LLP, 2101 L Street, NW, Washington, DC, 20037, US

(73) Assignee: MICRON TECHNOLOGY, INC.

(21) Appl. No.: 11/034,000

(22) Filed: Jan. 13, 2005

(51) Int. Cl. H04N 5/76

(52) U.S. Cl. 348/231.99

(57) ABSTRACT

The present invention relates to a digital camera having an imager pixel array and memory for storing images from the array, the memory is programmable to non-rewritably store images for subsequent readout. The non-rewritable memory storage permits a low cost image storage enabling the camera to be disposable or reconditioned for reuse.

### FIELD OF THE INVENTION

The invention relates generally to a photo image capturing device and more particularly to a disposable or recyclable digital camera.

### BACKGROUND OF THE INVENTION

Currently, disposable cameras are limited to film varieties. A traditional disposable camera includes film that is inserted during production and after the film is finished, the whole camera is taken to a film processing center where the film is developed and the printed images are returned to the customer.

Solid state imaging devices having pixel arrays, including charge coupled devices (CCD) and complementary metal oxide semiconductor (CMOS) devices, are commonly used in photo-imaging applications. A CMOS imager circuit, for example, includes a focal plane array of pixel cells, each including a photosensor, for example, a photogate, photoconductor or a photodiode for accumulating photo-generated charge. Each pixel cell has a charge storage region, which is connected to the gate of an output transistor that is part of a readout circuit. The readout circuit connected to each pixel cell includes at least the output transistor, which receives photo-generated charges from the storage region and produces an output signal that is read-out through a pixel access transistor. In some imager circuits, each pixel may include at least one electronic device such as a transistor for transferring charge from the photosensor to the storage region and one device, also typically a transistor, for resetting the storage region to a predetermined charge level prior to charge transference.

CMOS imagers of the type generally discussed above are generally known as discussed, for example, in U.S. Pat.No. 6,140,630, U.S. Pat. No. 6,376,868, U.S. Pat. No. 6,310,366, U.S. Pat. No. 6,326,652, U.S. Pat. No. 6,204,524 and U.S. Pat. No. 6,333,205, assigned to Micron Technology, Inc., which are hereby incorporated by reference in their entirety.

An exemplary digital camera employing a solid state CMOS imager is illustrated in block diagram found in FIG. 1. As shown, an exemplary CMOS imager 308 has a pixel array 240 comprising a plurality of pixels arranged in a predetermined number of columns and rows, with each pixel cell being constructed as described above. Attached to the array 240 is signal processing circuitry. The pixels of each row in array 240 are all turned on at the same time by a row select line, and the pixels of each activated row are selectively output by respective column select lines. A plurality of row and column select lines are provided for the entire array 240. The row lines are selectively activated by a row driver 245 in response to row address decoder 255. The column select lines are selectively activated by a column driver 260 in response to column address decoder 270. Thus, a row and column address is provided for each pixel.

The CMOS imager 308 is operated by the timing and control circuit 250, which controls address decoders 255, 270 for selecting the appropriate row and column lines for pixel readout. The control circuit 250 also controls the row and column driver circuitry 245, 260 such that they apply driving voltages to the drive transistors of the selected row and column select lines. The pixel column signals, which for a CMOS imager typically include a pixel reset signal (Vᵣₛₜ) and a pixel image signal (V_{sig}), are read by a sample and hold circuit 261. Vᵣₛₜ is read from a pixel immediately after a charge storage region is reset. V_{sig} represents the amount of charges generated by the pixel's photosensitive element and stored in the charge storage region in response to applied light to the pixel. A differential signal (Vᵣₛₜ- V_{sig}) is produced by differential amplifier 262 for each pixel. The differential signal is digitized by analog-to-digital converter 275 (ADC). The analog-to-digital converter 275 supplies the digitized pixel signals to an image processor 280, which forms and outputs a digital image.

A removable repeatably rewritable memory 281 is typically associated with the image processor 280 and/or another camera processor 282 for storing the digital image. Alternatively separate memories may be respectively associated with each of the processors 280, 282, with one containing an outputted image being removable. Typical digital cameras are costly in part because the rewriteable memory associated with the processor 280 and/or 282 is expensive.

### BRIEF SUMMARY OF THE INVENTION

The present invention relates to a low cost digital camera having a one time programmable memory for storing the digital images acquired by a connected digital imager. Because of the lowered costs associated with the one time programmable memory, the digital camera may be disposable or recyclable, whereby the user has the advantages of a digital camera in a disposable and/or recyclable low cost form. The camera permits a user to directly download images onto to a computer or other storage device or optionally remove the one-time programmable memory chip to store and read the stored images.

### BRIEF DESCRIPTION OF THE DRAWINGS

The foregoing and other advantages and features of the invention will become more apparent from the detailed description of exemplary embodiments provided below with reference to the accompanying drawings in which:

FIG. 1 illustrates a conventional imager device;

FIG. 2 illustrates an imager and memory device according to an embodiment of the invention;

FIG. 3 illustrates an imager and memory device according to another embodiment of the invention;

FIG. 4 illustrates the outer view of a disposable digital camera constructed in accordance with an embodiment of the invention;

FIG. 5 illustrates an internal circuitry of a disposable digital camera constructed in accordance with an embodiment of the invention;

FIGS. 6A and 6B illustrate exemplary operational embodiments of the invention; and

FIGS. 7A, 7B, 7C, 7D and 7E illustrate additional exemplary operational embodiments of the invention.

### DETAILED DESCRIPTION OF THE INVENTION

In the following detailed description, reference is made to the accompanying drawings, which are a part of the specification, and in which is shown by way of illustration various embodiments whereby the invention may be practiced. These embodiments are described in sufficient detail to enable those skilled in the art to make and use the invention. It is to be understood that other embodiments may be utilized, and that structural, logical, and electrical changes, as well as changes in the materials used, may be made without departing from the spirit and scope of the present invention.

The digital camera of the present invention includes a one time programmable memory, also termed non-rewritable memory 28 having associated programmable elements 29, in place of the reprogrammable memory 281 typically associated with the solid state imager 308.

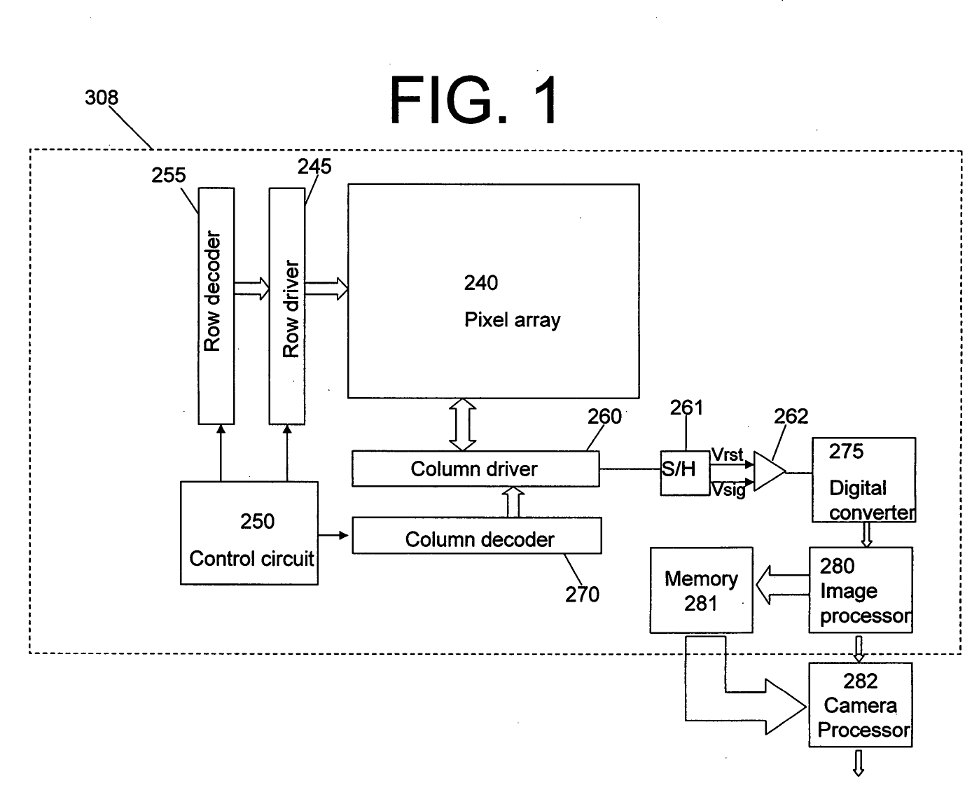

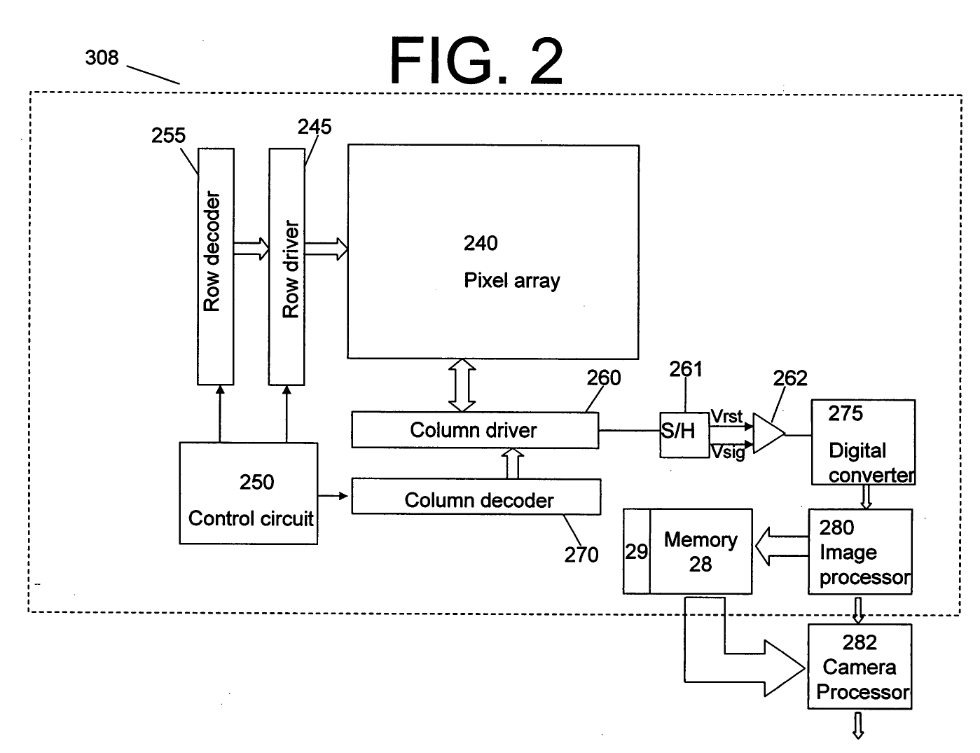

A first exemplary embodiment of the invention is illustrated in FIG. 2. A CMOS imager 308, of the type depicted in FIG. 1, or another CMOS, CCD or other solid state imager, is provided for capturing and producing digital images. The digital images are stored in memory 28 having associated programmable elements 29, which are selectively programmed to make the images stored in memory 28 non-rewritable. The illustrated CMOS imager 308 includes an integrated image processor 280 for loading image data from an analog-to-digital converter 275 into the one time programmable memory 28, programming the programmable elements 29, and for managing readout of that data. In this regard, the imager 308 of FIG. 2 may be the same as illustrated in FIG. 1, with a one time programmable memory 28 and associated programmable elements 29 used in place of rewriteable memory 281. The image data may be processed by processor 280 before it is stored in the one time programmable memory 28. A low grade, inexpensive, processor 280 may be used to transfer the pixel data from the analog-to-digital converter 275 into the memory 28 and programmable elements 29.

The one time programmable memory 28 stores digital camera images for later retrieval. The one time programmable memory 28 has multiple image storage areas for storing multiple images. However, it is contemplated that the memory 28 may also only include a single storage area for storing only one image. Upon image capture and storage in memory 28, the processor 280 applies a programming voltage to the programmable elements 29. The programmable elements 29 are associated with image storage areas and are formed as fuses or anti fuses. The programmable elements 29 are part of the one time programmable memory 28 which, when programmed by the processor 280, cause stored images to become non-rewritable. The processor 280, upon storing an image within memory 28, will also program the programmable elements 29 and cause stored images to be non-rewritable. If the programmable elements 29 are not programmed, the image data is not permanently stored in the memory 28 and can be erased and rewritten. Each image storage area of the one time programmable memory 28 may have its own programmable element 29 to set the image storage area as non-rewritable. Alternatively, once the memory 28 is full, the image processor 280 may program a single programmable element 29 to make all of the image storage areas of memory 28 non-rewritable. A particular memory format is not critical to the invention. Any memory formats suitable for use with a digital camera may be employed, including formatting the memory to one of the standards of Secure Digital Memory or CompactFlash®, for example.

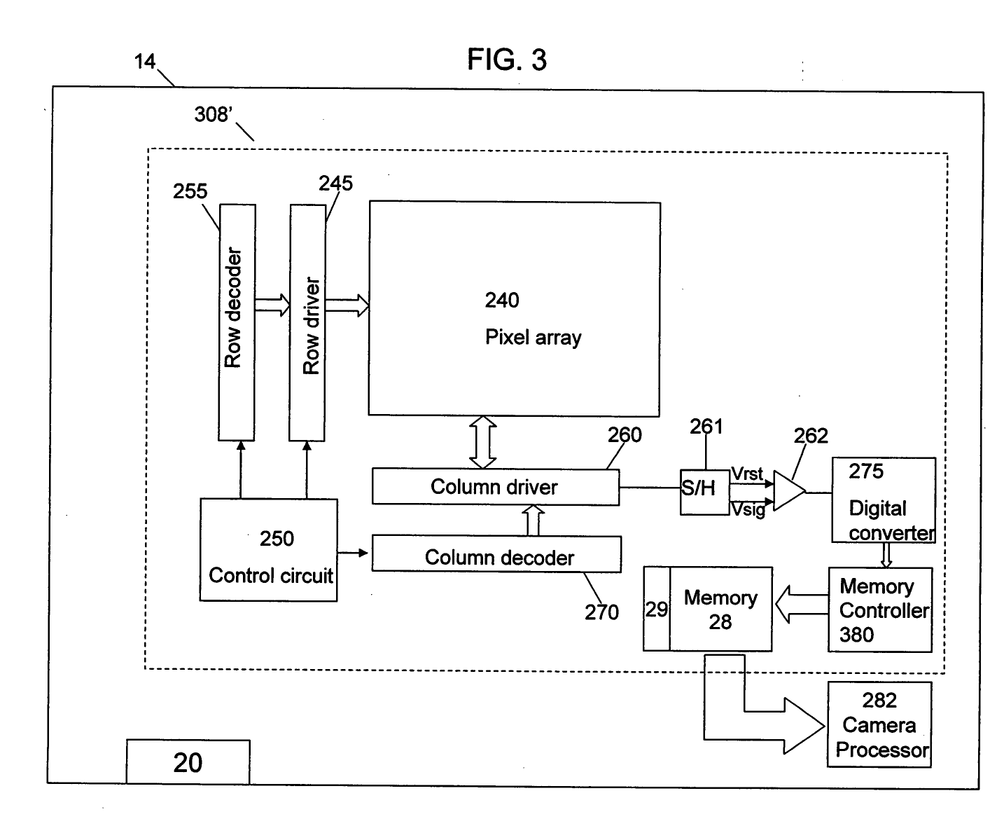

An alternate exemplary embodiment of the invention is illustrated in FIG. 3 in which the solid state imager 308 includes a memory controller 380 to store raw image data into memory 28 and program the programmable elements 29 to make the stored images non-rewritable. In this embodiment, the image processor, e.g. element 280 in FIG. 2, can be omitted to further reduce costs. In this embodiment only raw image data from the output of the analog-to-digital converter 275 is stored in memory 28. Any needed or desired image processing may later be done on the stored images by a computer or by a traditional print processing lab.

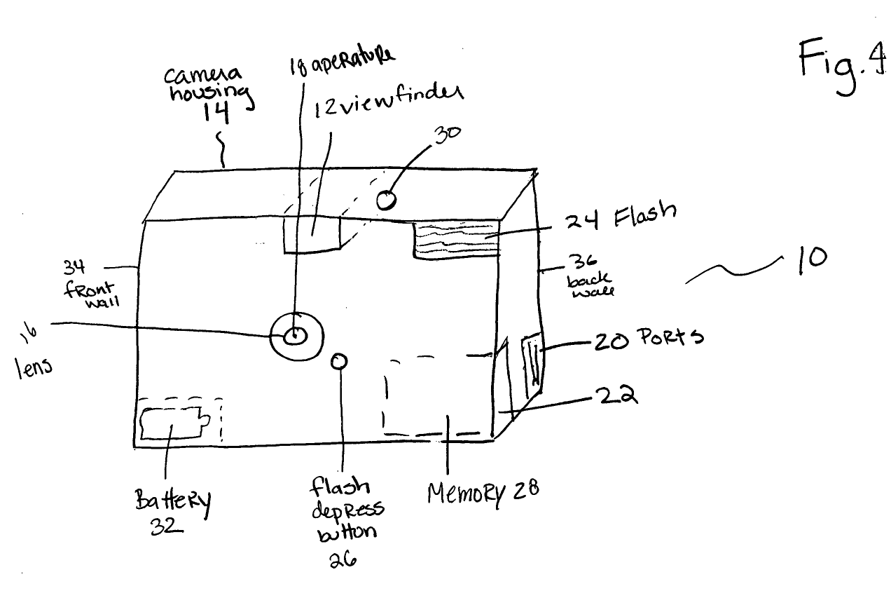

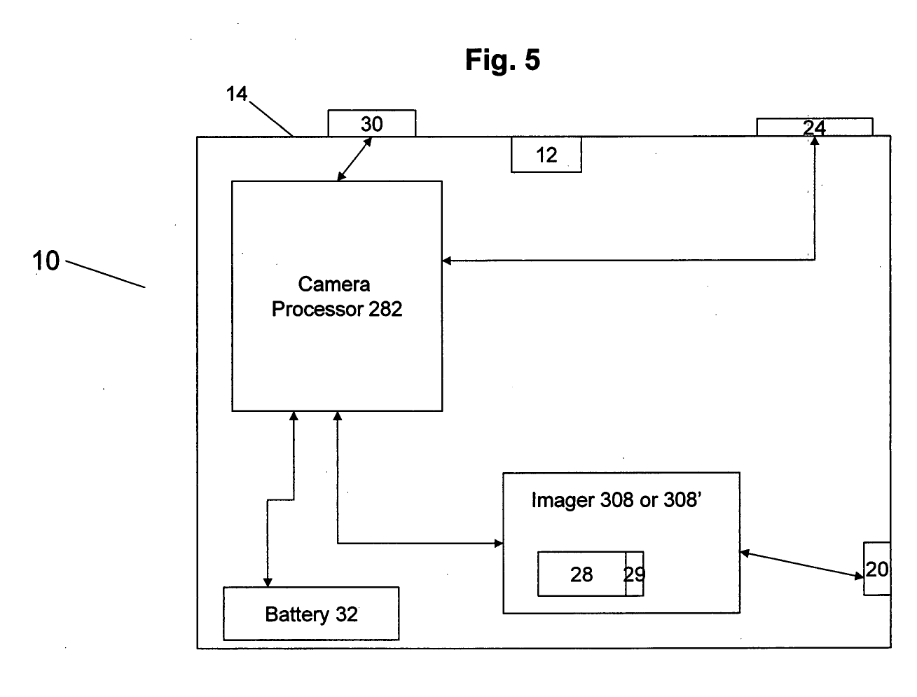

FIGS. 4 and 5 depict a disposable and/or recyclable camera 10 containing memory 28 and associated programmed elements 29. The user may access the camera memory 28 for image readout in different ways. As shown in FIGS. 4 and 5, the camera housing 14 includes at least one port 20 that allows the user to directly or wirelessly connect to an external computer or other device to read and copy the image data stored on the one time programmable memory 28. The camera processor 282 controls access to the memory 28 through the ports 20. For example, the connection methods may include a USB cable or USB memory. Additionally, the user has the ability to remove the memory 28 from the camera housing 14 itself. The user may remove the memory 28 and access the accessible images using commercial reading devices, including a card reader or a printer.

The illustrated camera 10 may include use of a single focal length lens 16 or multiple and/or more complex lenses may be used. Optionally, the camera housing 14 may allow for the attachment of additional lenses. The lens 16, and pixel array of an imager, e.g. imager 308 (FIG. 2) or 308′ (FIG. 3), (not shown in FIG. 4) and an aperture 18 are optically aligned, as known in the art. The lens 16 and aperture 18 control the amount of light that reaches and is processed by the imager, e.g. 308 or 308′. The system may include a shutter system or the imager array can be turned on and off, by the camera processor 282, to act as a mechanical shutter would. A CMOS imager, e.g. 308 or 308′, or other imager, will process the data in the pixel array 240 to produce image data for storage in memory 28.

As with disposable film cameras, the camera housing 14, illustrated in FIGS. 4 and 5, must be made of sturdy but inexpensive material, such as e.g., plastic. The housing 14 may also include parts made from metal, cardboard or other sturdy and inexpensive material. A button 30 is connected on top of the camera housing 14 for taking the picture, which will either open the shutter system or will turn the imager array on to allow it to collect image data, as depicted in FIGS. 4 and 5. The camera housing 14 may include an opening in its front and back walls 34, 36, which are aligned to act as a viewfinder 12. Optionally, the camera may include a flash 24, controlled by the camera processor 282, for providing additional light while an image is being recorded by the imager, e.g. 308 or 308′. The camera 10 functions are powered through the use of a battery 32 which may be removable.

Once the memory 28 is full, the camera 10 is no longer usable without replacement of the memory 28. It should be appreciated, the memory 28 and/or camera 10 may optionally be reconditioned by an authorized reconditioner (recycling) or the user can dispose of the camera after downloading the stored image(s) or removing the memory 28. The camera 10 may be reconditioned by inserting a new programmable memory card 28 in the camera housing 14 and resetting all counters. Reconditioning and resetting may only be done by an authorized dealer.

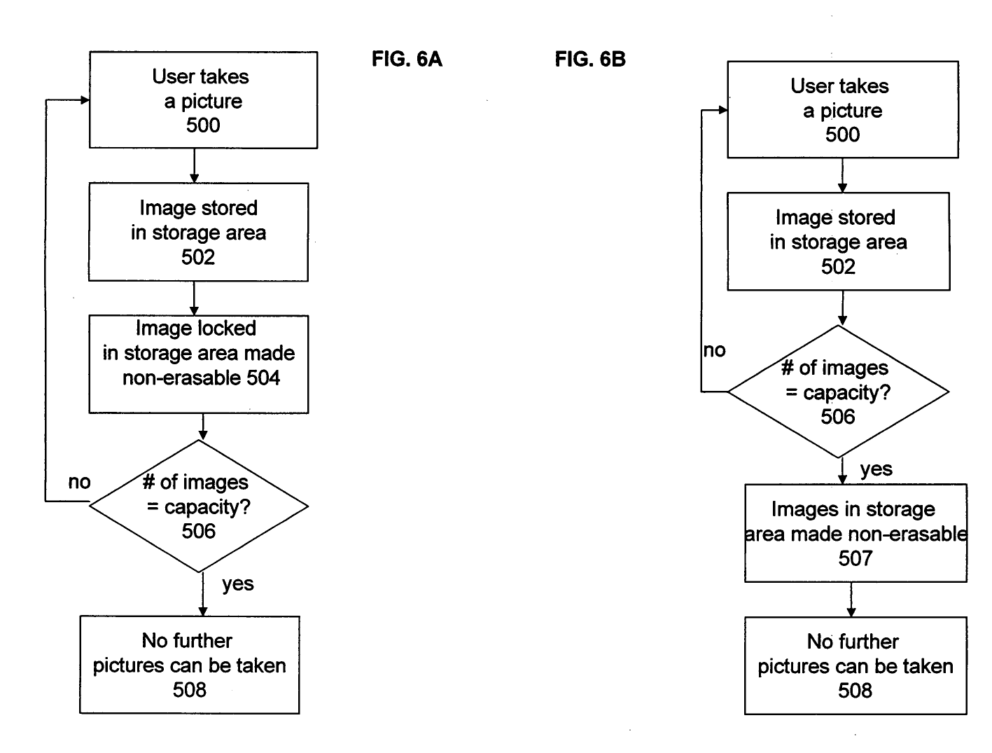

Operations preformed by the image processor 280 of FIG. 2, or the memory controller 380 in FIG. 3 in storing images in memory 28 and making them non-rewritable are now described in greater detail. FIG. 6A depicts the steps taken to store an image using either one programmable element 29 per one pixel storage area of memory 28 or one programmable element 29 per one image storage area of memory 28. First, the user operates the camera 10 to take a picture at step 500. The image is stored in the storage area of the memory at step 502 and then made non-rewritable at step 504 by the programming of one or more programmable elements 29. If the total number of pictures stored by the memory is equal to the memory 28 storage capacity as determined at step 506, no further pictures can be taken at step 508. When the total number of images is not equal to capacity, the user may operate the camera 10 to take another picture at step 500. In this embodiment, there is either one programmable element 29 for each pixel data stored in memory 28, that is, one element for each pixel of array 240, or one programmable element 29 for the memory storage area of an entire image.

An exemplary operational alternative embodiment, shown in FIG. 6B, allows for the implementation of a single programmable element 29 to make all of the images stored in the entire memory 28 non-rewritable at once. The user operates the camera 10 to take a picture at step 500. The image is stored in the storage area of the memory 28 at step 502 and if it is determined that the number of images equals the storage capacity of the memory at step 506, all of the images are made non-rewritable in step 507 by programming of a programmable element 29. If the total number of pictures does not equal the memory 28 storage capacity as determined in step 506, the user may take an additional picture at step 500 until the storage capacity of memory 28 is reached and all images are made non-rewritable in step 507.

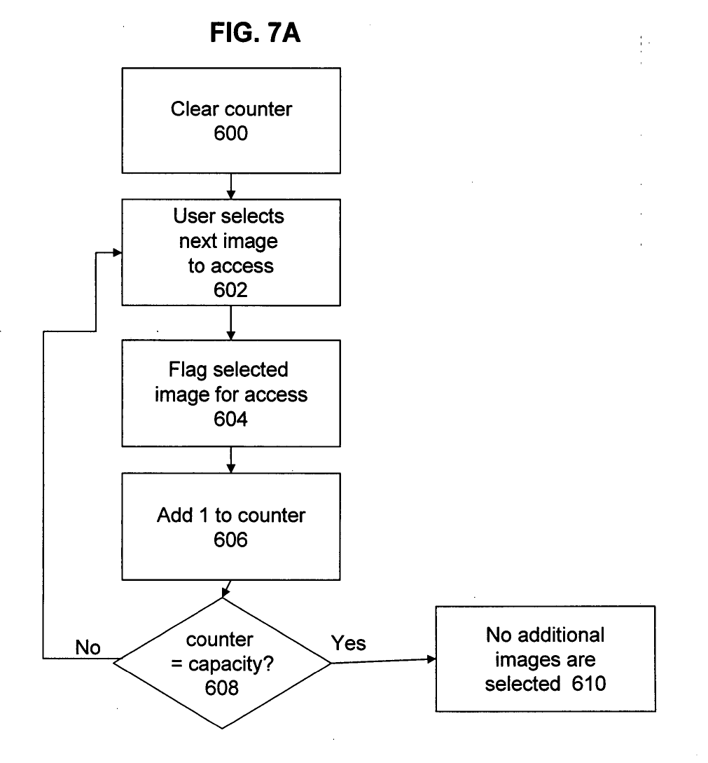

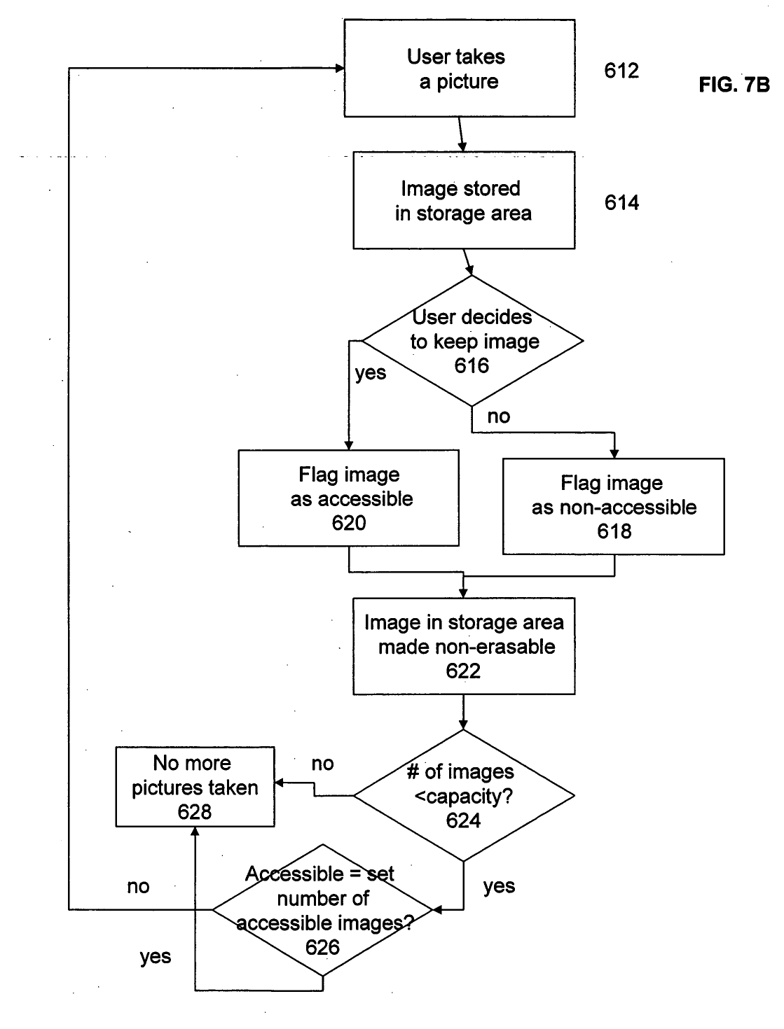

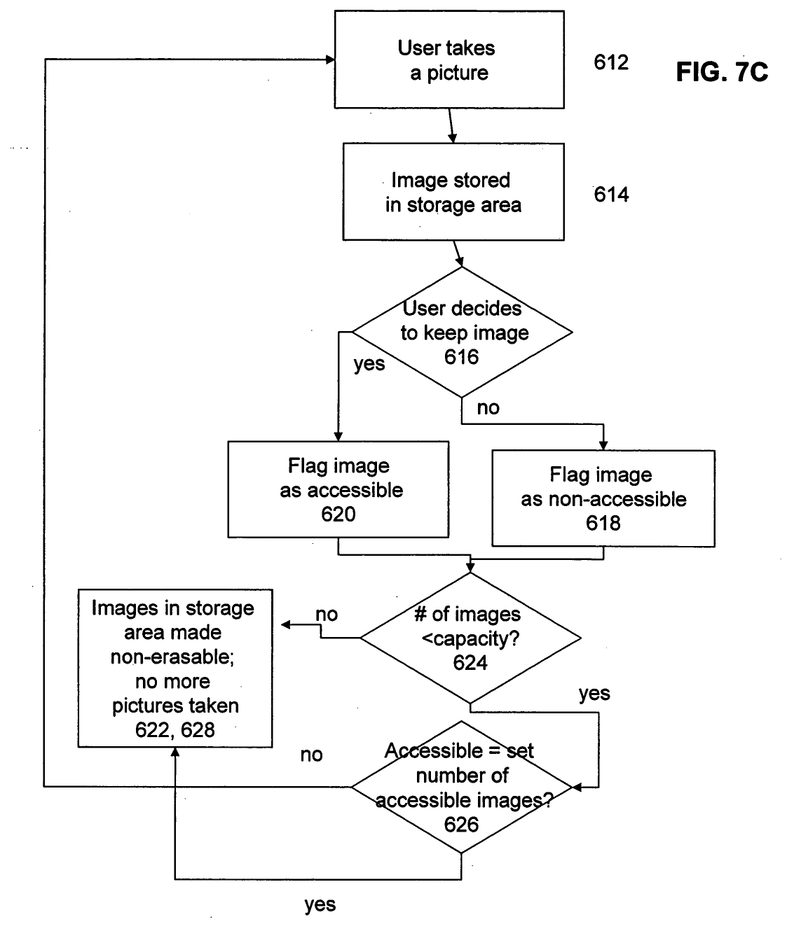

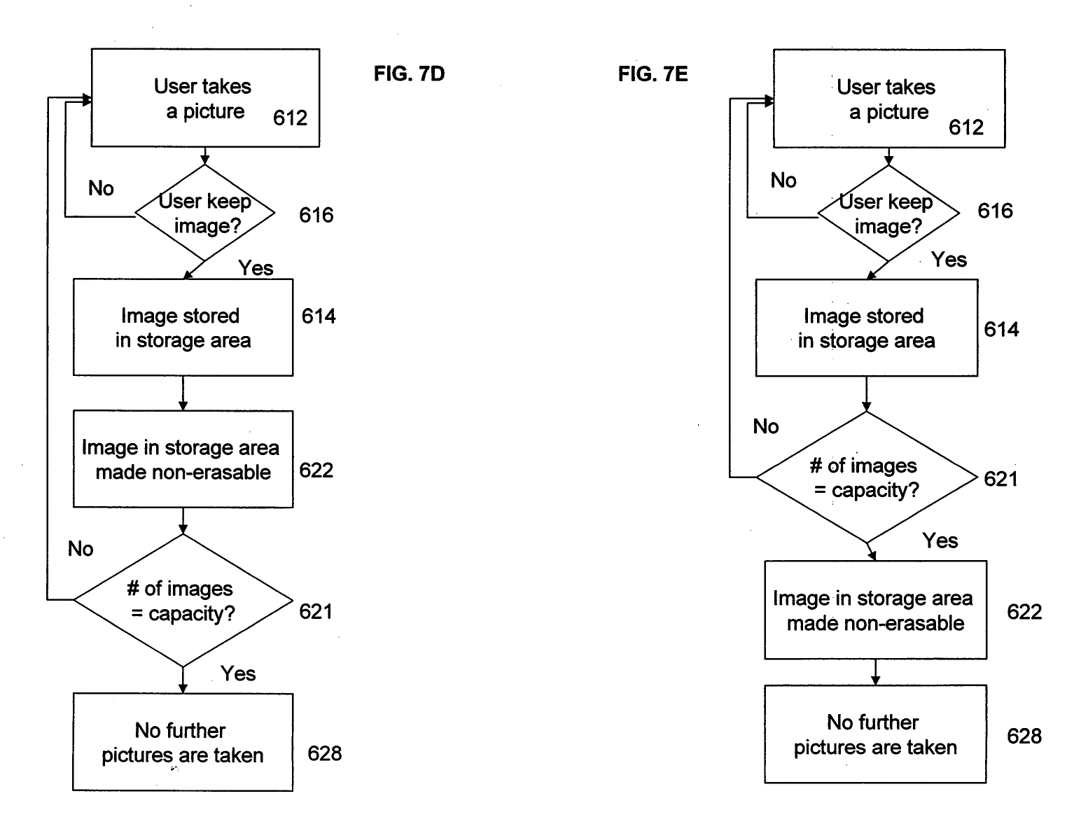

In another exemplary operation embodiment, the programmable memory 28 may also be designed to allow the user to discard several unwanted images. In the operations depicted in FIGS. 6A and 6B, exemplary operational embodiments the camera user can take a set number of pictures corresponding to the capacity, i.e. number of image storage areas, of memory 28. In another operational embodiment depicted in FIG. 7A, the user can take more than a set number of pictures, but the user will be required to delete or deselected the extra images. Thus, as illustrated in FIG. 7A, after a set of number of images are stored, which exceed the number of images permitted for the user to store and reproduce, the user may select images previously taken and stored in memory 28 that they want to keep as later accessible for readout. In this embodiment, a flag in each storage area will hold information identifying if the picture is accessible for readout. If a flag is set to non-accessible, the user will not be able to access the image for readout, although it is stored in memory 28. In this operational use, after the images are stored and made non-rewritable, an initial operational step clears a counter 600. The user then selects a stored image as accessible at step 602 and a flag is set for later image access at step 604. A count of one is added to the counter at step 606. If the total number of pictures permitted for access is not met at step 608, the user may select another image to flag for access and readout at step 602. Alternatively, if the number of images to be accessed equals the number of images selected at step 608, the user cannot select any additional images at step 610. With this embodiment a user may operate a camera 10 to take a larger number of images which are non-erasably stored in memory 28, but only those flagged as accessible are capable of being readout. Instead of flagging these images as accessible for readout in the FIG. 7A embodiment, the process can also be arranged so the user flags the non-accessible image, permitting readout of only the non-flagged images from memory 28.

FIG. 7B depicts yet another operational embodiment where the user may select the acquired images that they want to keep as accessible, as the images are acquired. In this embodiment the user decides whether to keep an image immediately after it is taken. First, the user operates the camera 10 to take a picture at step 612 and the image is stored in memory at step 614. If the user decides to keep the image at step 616, the image is flagged as accessible for readout at step 620. If the user decides not to keep the image at step 616, the image is flagged as non-accessible at step 618. One or more programmable element(s) 29 are then programmed, at step 622, to make the image in memory 28 non-rewritable, regardless of how it is flagged. It is next determined whether the total number of images taken is less than memory 28 capacity at step 624. If the total number of images taken equals the memory 28 capacity, the user cannot take any more pictures at step 628. However, if the number of pictures taken is less than the number allowed as determined in step 624, the total number of images selected as accessible is compared to the number of allowed accessible images at step 626. If the user has taken less than the total number of allowed accessible images at step 626, the user may take another image at step 612. If the number of accessible images is equal to the number of allowed accessible images, the user cannot take any additional pictures at step 628.

In yet another operational embodiment illustrated in FIG. 7C, the images can be non-erasably stored into memory 28 after all of the images have been taken. First, the user operates the camera 10 to take a picture at step 612 and the image is stored in memory at step 614. If the user decides to keep the image at step 616, the image is flagged as accessible at step 620. If the user decides not to keep the image at step 616, the image is flagged as non-accessible at step 618. It is next determined whether the total number of images taken is less than memory 28 capacity at step 624. If the total number of images taken equals the capacity the user cannot take any more pictures at step 628 and the programmable element 29 is used to make all stored images non-rewritable at step 622. However, if the number of pictures taken is less than the number allowed as determined in step 628, the total number of images selected as accessible is compared to the number of allowed accessible images at step 626. If the user has taken less than the total number of allowed accessible images at step 626, the user may take another image at step 612. If the number of accessible images is equal to the number of allowed accessible images, the user cannot take any additional pictures at step 628 and one or more programming elements 29 are programmed to make all stored images in memory 28 non-rewritable in step 622.

In yet other operational embodiments illustrated in FIG. 7D and 7E, the user may choose not to keep an image before it is stored in memory 28. Referring first to FIG. 7D, the user operates the camera 10 to take a picture at step 612 and the user decides whether to keep the image at step 616. If the image is not selected to be retained, the user may take another image at step 612. If the user decides to retain the image, the image is stored in memory 28 at step 614 and made non-rewritable by programming one or more programmable elements at step 622. In step 621 the number of images is checked to determine whether the total number of images stored equals the memory 28 capacity at step 621. If the number of images is less than the capacity, the user may take another picture at step 612. If the total number of pictures taken equals capacity, then the user cannot take any more pictures at step 628.

Referring to the operational embodiment in FIG. 7E, the user operates the camera 10 to take a picture at step 612 and the user decides whether to keep the image at step 616. If the image is not selected to be retained, the user may take another picture at step 612. If the user decides to retain the image, the image is stored in memory 28 at step 614. The number of images stored is then compared to the memory 28 capacity, in step 621, to determine whether the total number of images stored equals the memory 28 capacity. If the number of images equals capacity, all stored images are made non-rewritable in memory 28 by programming one or more programmable elements 29 at step 622 and the user cannot take any more pictures at step 628. If the number of images is less than the capacity, the user may take another picture at step 612.

Some of the embodiments described above employ a counter which is incremented up, however, it is contemplated that the counter may also be implemented by counting down to a preset number. Additionally, both the initial and ending values of the counter can be set to any predetermined number.

In all the forgoing operational embodiments, the illustrated processing may be conducted by the image processor 280 in the FIG. 2 embodiment or by the memory controller 380 in the FIG. 3 embodiment.

The processes and devices described above illustrate exemplary methods and devices of many that could be used to implement the invention. The above description and drawings illustrate exemplary embodiments of the present invention. However, it is not intended that the present invention be strictly limited to the above-described and illustrated embodiments and is only limited by the scope of the appended claims.

What is claimed as new and desired to be protected by Letters Patent of the United States is:

1. A digital camera comprising:
a camera housing;
a lens formed in a wall of the housing;
an imager pixel array contained within said housing, said imager pixel array for collecting image data based on light passing through said lens; and
a memory having at least one memory location for non-rewritably storing said image data.

2. A digital camera according to claim 1, wherein said memory has at least one associated programming control element for programming stored image data to be non-rewritable.

3. A digital camera according to claim 1, wherein the memory location includes at least one associated programmable area for storing data specifying whether a stored image is accessible for readout.

4. A digital camera according to claim 1, further comprising a memory control element which permits disposal of selected image data before it is transferred to said memory.

5. A digital camera according to claim 1, wherein said memory is arranged and configured to be removable from said camera housing.

6. A digital camera according to claim 1, wherein said camera is reconditionable by replacing the memory.

7. A digital camera according to claim 1, wherein said imager pixel array is a CMOS imager array.

8. A digital camera according to claim 1, wherein said imager pixel array is a CCD imager array.

9. A digital camera according to claim 2, further comprising a plurality of programming control elements respectively associated with a plurality of memory locations.

10. A digital camera according to claim 2, further comprising a plurality of programmable elements respectively associated with a single pixel of said image data.

11. A digital camera according to claim 1, where said memory comprises multiple memory locations for non-erasably storing a plurality of images

12. A digital camera according to claim 1, further comprising a communications port for accessing said image data stored in said memory.

13. A digital camera according to claim 1, further comprising a processor for storing said pixel data in said memory.

14. A digital camera according to claim 1, further comprising a memory controller for storing said pixel data in said memory.

15. A method of operating a digital camera, said method comprising:
converting an optical image into a digital image by an imager; and
non-erasably storing the digital image in memory of said camera.

16. The method according to claim 15, wherein said act of storing further comprises:
transferring said digital image to said memory; and
programming at least one programmable element associated with said stored image to make said stored image non-rewritable.

17. A method of acquiring and storing images in a digital camera comprising:
acquiring image data in a pixel array;
storing said image data in one of a plurality of memory locations;
programming said image data in said memory locations making the image data non-rewritable; and
determining whether the number of said stored image data is equal to a memory capacity, wherein when said number of image data equals said memory capacity no additional images are acquired.

18. A method of operating a digital camera comprising:
setting a counter to an initial preset value;
selecting an acquired image for permitted readout;
flagging said selected image;
altering said counter in a predetermined direction when said selected image is flagged; and
testing whether a memory capacity is met by the contents of said counter reaching a predetermined value, wherein when said memory capacity is met no additional images are selected.

19. A method of operating a digital camera comprising:
acquiring image data;
storing said image data in one of a plurality of memory locations;
selecting whether said image data is accessible or non-accessible for readout;
flagging said image data based on said selection;
determining whether the number of said stored image data is less than a memory capacity, wherein when said number of stored image data is greater than or equal to said capacity not permitting the acquisition of image data;
determining whether the number of said stored image data flagged as accessible is equal to a set number of accessible image data, wherein when said number of said stored image data flagged as accessible is equal to said set number of accessible images preventing the acquisition of image data; and
programming said stored image data to make it non-rewritable.

20. A method of acquiring and storing images in a digital camera comprising:
acquiring image data in a pixel array;
determining whether to retain said image data, wherein when image data is not retained new image data is acquired;
storing retained image data in one of a plurality of memory locations;
determining whether the number of said stored image data is equal to a memory capacity, wherein when said number of stored image data equals a memory capacity no additional images are acquired; and
programming said image data in said memory locations making the stored image data non-rewritable.

21. A digital camera comprising:
a disposable camera housing;
a lens formed in a wall of the housing;
an imager pixel array contained within said housing for collecting image data based on light passed through said lens;
a removable programmable memory for storing the image data collected by said pixel array; and
at least one programming control element associated with said memory for causing said image data in said memory to be non-rewritable.

22. A digital camera according to claims 21, wherein said memory is comprised of multiple memory locations for non-rewritably storing a plurality of images.

23. A digital camera according to claim 21, wherein said memory location has an associated stored data specifying whether the image is readable.

24. A digital camera according to claim 21, wherein the camera is arranged and configured to be reconditioned by replacing said memory made non-rewritable.

25. A digital camera according to claim 21, wherein said imager pixel array is a CMOS imager array.

26. A digital camera according to claim 21, wherein said imager pixel array is a CCD imager array.
